(19) United States
(12) Patent Application Publication
(10) Pub. No.: US 2011/0135226 A1
(43) Pub. Date: Jun. 9, 2011

(54) LINEAR MOTION GUIDANCE APPARATUS

(75) Inventor: Toru Takahashi, Tokyo (JP)

(73) Assignee: THK CO., LTD., Tokyo (JP)

(21) Appl. No.: 12/674,756

(22) PCT Filed: Jul. 11, 2008
(86) PCT No.: PCT/JP2008/062601

§ 371 Date: Feb. 23, 2010

(30) Foreign Application Priority Data
Aug. 30, 2007 (JP) 2007-224695

(51) Int. Cl. F16C 29/06

(52) U.S. Cl. 384/43

(57) ABSTRACT

A linear motion guidance apparatus suppresses a waving phenomenon, and includes a track rail with rolling member rolling grooves along the longitudinal direction, a movable block with loaded rolling member rolling grooves that face the rolling member rolling grooves, and a plurality of balls rollably provided in loaded rolling paths formed of the rolling member rolling grooves and the loaded rolling member rolling grooves. The movable block can make reciprocating motion in the longitudinal direction of the track rail. The linear motion guidance apparatus is configured so that the diameter of each of the balls is 1/10 of the width of the track rail or smaller and the movable block has a block length compliant with ISO. The number L of endless circulation paths is L=4×N (N is a natural number greater than or equal to two), and in particular, the number of paths L is preferably eight.

### TECHNICAL FIELD

The present invention relates to a linear motion guidance apparatus, and particularly to a linear motion guidance apparatus in which the precision in motion is improved by suppressing a waving phenomenon.

### BACKGROUND ART

A linear motion guidance apparatus that guides a machine in linear motion by using rotation of rolling members is presently used in a machine apparatus in every field. To improve the precision in motion (such as positioning precision, tracking precision, and traveling precision), a variety of improvement efforts has been made to linear motion guidance apparatus of this type, and those improvement efforts have resulted in precision linear motion guidance apparatus having a straightness precision per 300 mm ranging from 0.5 to 1.0 μm and a waving precision ranging from 0.05 to 0.1 μm, as shown, for example, in Table 1 below.

TABLE 1
Generally known precision in motion

Unit: μm:

| | Typical | Precise |
|---|---|---|
| Straightness precision/300 mm | 1.0 or greater | 0.5-1.0 |
| Waving precision | 0.1 or greater | 0.05-0.1 |

These improvement efforts have been historically made by accumulating improvement technologies, such as optimizing the shape of a crowning provided in a portion where the state of endlessly circulating balls changes from an unloaded state to a loaded state in order to allow the balls to smoothly roll.

### DISCLOSURE OF THE INVENTION

### Problems to be Solved by the Invention

In the industry of the art in recent years, however, linear motion guidance apparatus are required to be more precise. For example, it is required to achieve a super-precision linear motion guidance apparatus having excellent precision in motion, such as a straightness precision per 300 mm ranging from 0.1 to 0.5 μm and a waving precision ranging from 0.01 to 0.05 μm (see Table 2 below). Further, once such a super-precision linear motion guidance apparatus has been achieved, a further advanced target will be considered in the hope of achieving an extra-super-precision linear motion guidance apparatus having the precision in motion shown in Table 2. To achieve such a super-precision linear motion guidance apparatus, there has been a technical barrier to be solved, that is, minimizing a waving phenomenon.

TABLE 2
Generally known precision in motion and target precision

Unit: μm:

| | | | Very precise | Extremely |
|---|---|---|---|---|
| | Typical | Precise | (target values) | precise |
| Straightness | 1.0 or greater | 0.5-1.0 | 0.1-0.5 | 0.1 or smaller |
| precision/ | | | | |
| 300 mm | | | | |
| Waving | 0.1 or greater | 0.05-0.1 | 0.01-0.05 | 0.01 or smaller |
| precision | | | | |

That is, the waving phenomenon is attitude change or vibration (pulsing motion) of a movable block resulting from a periodical shift in position relative to a groove along which rolling members roll. Minimizing the waving phenomenon closely relates to the crowning formed at both ends of the groove along which the movable block travels, that is, the boundary between unloaded and loaded areas along the rolling-motion grove, and efforts have been made to minimize the waving by optimizing the shape of the crowning.

Only improvements from the viewpoint of optimizing the shape of the crowning, however, hardly achieves a super-precision linear motion guidance apparatus required in the industry of the art, and improvement technologies from a new point of view are required.

The present invention has been made in view of the case described above. An object of the present invention is to provide a super-precision linear motion guidance apparatus required in the industry of the art by suppressing the waving phenomenon.

### Means for Solving the Problems

A linear motion guidance apparatus according to the present invention includes a track rail on which rolling member rolling grooves are formed along the longitudinal direction, a movable block on which loaded rolling member rolling grooves that face the rolling member rolling grooves are formed, and a plurality of balls rollably provided in loaded rolling paths formed of the rolling member rolling grooves and the loaded rolling member rolling grooves, the movable block capable of making reciprocating motion in the longitudinal direction of the track rail. The linear motion guidance apparatus is characterized in that the diameter of each of the balls is 1/10 of the width of the track rail or smaller.

Another linear motion guidance apparatus according to the present invention includes a track rail on which rolling member rolling grooves are formed along the longitudinal direction, a movable block on which loaded rolling member rolling grooves that face the rolling member rolling grooves are formed, and a plurality of balls rollably provided in loaded rolling paths formed of the rolling member rolling grooves and the loaded rolling member rolling grooves, the movable block capable of making reciprocating motion in the longitudinal direction of the track rail. The linear motion guidance apparatus is characterized in that the diameter of each of the balls is 1/10 of the width of the track rail or smaller and the movable block has a block length compliant with ISO.

In the linear motion guidance apparatus according to the present invention, the movable block preferably includes a movable block body on which the loaded rolling member rolling grooves are formed and in which unloaded rolling paths substantially parallel to the loaded rolling member rolling grooves are formed, and a pair of side lids in which direction reversing paths that allow the ends of the loaded rolling paths to communicate with the corresponding ends of the unloaded rolling paths are formed, the pair of side lids attached to both ends of the movable block body. The number L of endless circulation paths formed of the loaded rolling paths, the unloaded rolling paths, and the pair of direction reversing paths is preferably 4×N (N is a natural number greater than or equal to two).

In the linear motion guidance apparatus according to the present invention, the number L of endless circulation paths can be eight.

### Effects of the Invention

According to the present invention, the waving phenomenon can be suppressed, whereby a super-precision linear motion guidance apparatus required in the industry of the art can be provided.

### BRIEF DESCRIPTION OF THE DRAWINGS

FIG. 1 shows the shape of a linear motion guidance apparatus (Series 1) defined by relevant ISO standards and having dimensions shown in Table 3.

FIG. 2 shows the shape of a linear motion guidance apparatus (Series 2) defined by relevant ISO standards and having dimensions shown in Table 4.

FIG. 3 shows the shape of a linear motion guidance apparatus (Series 3) defined by relevant ISO standards and having dimensions shown in Table 5.

FIG. 4 shows the coordinate system of a linear motion guidance apparatus defined in a numerical analysis according to the present embodiment.

FIG. 5 shows the relationship between the ball diameter and the waving amplitude obtained by changing a reference length lₜ of a loaded rolling member rolling groove for a model number #15.

FIG. 6 shows the relationship between the ball diameter and the waving amplitude obtained by changing the reference length lₜ of the loaded rolling member rolling groove for a model number #25.

FIG. 7 shows the relationship between the ball diameter and the waving amplitude obtained by changing the reference length lₜ of the loaded rolling member rolling groove for a model number #45.

FIG. 8 shows the relationship between the ball diameter and the waving amplitude obtained by changing the reference length lₜ of the loaded rolling member rolling groove for a model number #55.

FIG. 9 shows the relationship between the ball diameter and the waving amplitude obtained by changing the reference length lₜ of the loaded rolling member rolling groove for a model number #65.

FIG. 10 shows the relationship between the ball diameter and the waving amplitude obtained by changing an external load from 0.10 to 0.50 C for the model number #25 and the reference length lₜ of the loaded rolling member rolling groove=100.

FIG. 11 clarifies a detailed relationship between the waving amplitude and the ball diameter by enlarging the waveform obtained as the result of the numerical analysis shown in FIG. 5.

FIG. 12 clarifies a detailed relationship between the waving amplitude and the ball diameter by enlarging the waveform obtained as the result of the numerical analysis shown in FIG. 6.

FIG. 13 clarifies a detailed relationship between the waving amplitude and the ball diameter by enlarging the waveform obtained as the result of the numerical analysis shown in FIG. 7.

FIG. 14 clarifies a detailed relationship between the waving amplitude and the ball diameter by enlarging the waveform obtained as the result of the numerical analysis shown in FIG. 8.

FIG. 15 clarifies a detailed relationship between the waving amplitude and the ball diameter by enlarging the waveform obtained as the result of the numerical analysis shown in FIG. 9.

FIG. 16 shows line graphs drawn to compare the results of analysis for the types shown in Table 7.

FIG. 17 is an exterior perspective view of a linear motion guidance apparatus according to the present example.

FIG. 18 is a longitudinal cross-sectional view of the linear motion guidance apparatus according to the present example.

### REFERENCE NUMERALS

60 linear motion guidance apparatus, 61 track rail, 61a rolling member rolling groove, 61b bolt attachment hole, 62 ball, 63 movable block, 64 movable block body, 64a loaded rolling member rolling groove, 64b upper surface, 64c female screw, 66 side lid, 67 loaded rolling path, 68 direction reversing path, 70 unloaded rolling path

### MODE FOR CARRYING OUT THE INVENTION

### Inventor's Idea

The inventor has reached for the first time an idea that reducing the size of the diameter of each ball used in a linear motion guidance apparatus may suppress the waving phenomenon, because the inventor has assumed that a smaller ball has higher rigidity and the increased rigidity may contribute to improvement in precision in motion. It is further conceivable that reducing the size of the balls leads to not only lower the load or contact pressure acting on each ball but also reduce the influence of the action of the balls getting in and out of a crowning, that is, the boundary at which the endlessly circulating balls move from an unloaded area to a loaded area, whereby the attitude change or vibration (pulsing motion) of a movable block can be minimized.

However, since no designer who has been involved in linear motion guidance apparatus has employed the design concept of reducing the diameter of each ball, because reducing the diameter of each ball disadvantageously reduces the load rating of a linear motion guidance apparatus. Therefore, in related art, efforts have been made to suppress vibration produced when the balls pass through a crowing, for example, by increasing the length of the movable block to increase the number of incorporated balls having a diameter used in related art and improve the precision in motion accordingly (see Japanese Patent Laid-Open No. 2000-46052, for example).

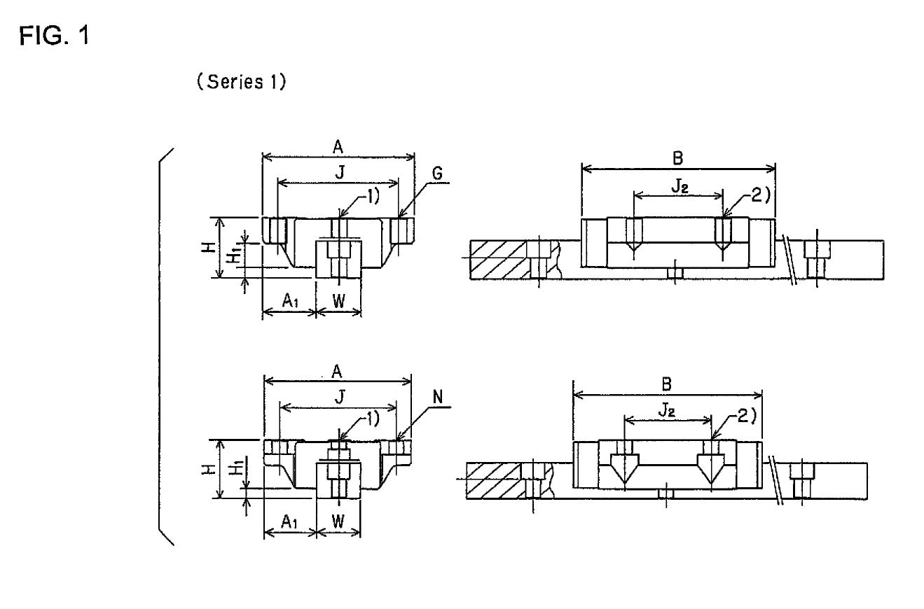

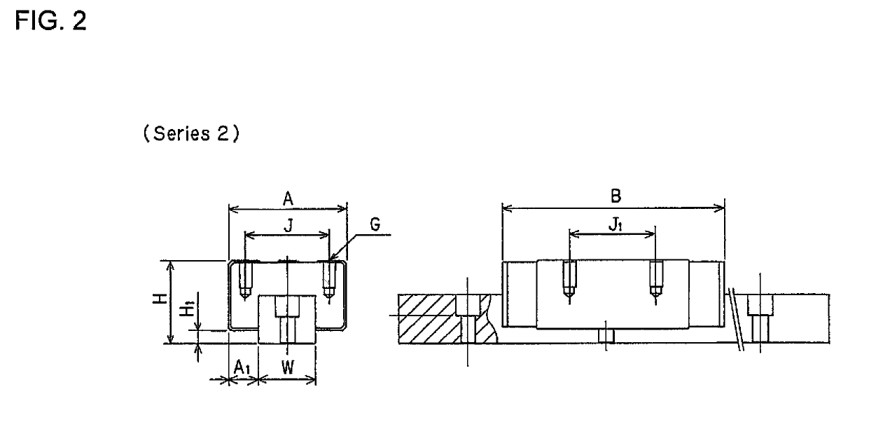

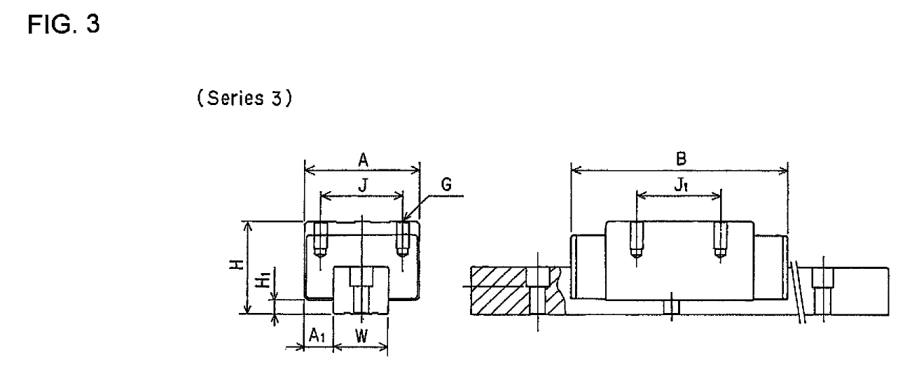

An increased length of the movable block, however, may depart from a length B_{MAX} of the movable block defined by relevant ISO standards shown in FIGS. 1 to 3 and Tables 3 to 5 corresponding to FIGS. 1 to 3 (ISO/CD 12090-1 and ISO/CD 12090-2), and is also problematic for users because use conditions are greatly limited.

TABLE 3
Dimensions in millimetres

| | | | | | | Design | | Design | | | | |
|---|---|---|---|---|---|---|---|---|---|---|---|---|
| | | | | | | 1M | | 1L | | | 2) | |
| | | | | | H₁ | B | | B | | | | N |
| Size | W | H | A | A_{I} | min | max | J₂ | max | J₂ | J | G | max |
| 15 | 15 | 24 | 47 | 16 | 3 | 72 | 30 | — | — | 38 | M5 | 4.5 |
| 20 | 20 | 30 | 63 | 21.5 | 4 | 92 | 40 | 112 | 40 | 53 | M6 | 6 |
| 25 | 23 | 36 | 70 | 23.5 | 4.5 | 100 | 45 | 118 | 45 | 57 | M8 | 7 |
| 30 | 28 | 42 | 90 | 31 | 4.5 | 113 | 52 | 139 | 52 | 72 | M10 | 9 |
| 35 | 34 | 48 | 100 | 33 | 5.5 | 130 | 62 | 155 | 62 | 82 | M10 | 9 |
| 45 | 45 | 60 | 120 | 37.5 | 7 | 159 | 80 | 194 | 80 | 100 | M12 | 11³⁾ |
| 55 | 53 | 70 | 140 | 43.5 | 7.5 | 191 | 95 | 238 | 95 | 116 | M14 | 14 |
| 65 | 63 | 90 | 170 | 53.5 | 10 | 229 | 110 | 309 | 110 | 142 | M16 | 16 |
| 85 | 85 | 110 | 215 | 65 | 16 | 247 | 140 | 303 | 185 | 185 | M20 | 18 |

TABLE 4
Dimensions in millimetres

| | | | | | | Design | | Design | | | |
|---|---|---|---|---|---|---|---|---|---|---|---|
| | | | | | | 2M | | 2L | | | |
| Size | W | H | A | A_{I} | H₁ min | B max | J₁ | B max | J₁ | J | G |
| 15 | 15 | 24 | 34 | 9.5 | 3 | 72 | 26 | — | — | 26 | M4 |
| 20 | 20 | 30 | 44 | 12 | 4 | 92 | 36 | 112 | 50 | 32 | M5 |
| 25 | 23 | 36 | 48 | 12.5 | 4.5 | 100 | 35 | 118 | 50 | 35 | M6 |
| 30 | 28 | 42 | 60 | 16 | 4.5 | 113 | 40 | 139 | 60 | 40 | M8 |
| 35 | 34 | 48 | 70 | 18 | 5.5 | 130 | 50 | 155 | 72 | 50 | M8 |
| 45 | 45 | 60 | 86 | 20.5 | 7 | 159 | 60 | 194 | 80 | 60 | M10 |
| 55 | 53 | 70 | 100 | 23.5 | 7.5 | 191 | 75 | 235 | 95 | 75 | M12 |
| 65 | 63 | 90 | 126 | 31.5 | 10 | 245 | 70 | 309 | 120 | 76 | M16 |

TABLE 5
Dimensions in millimetres

| | | | | | | Design | | Design | | | |
|---|---|---|---|---|---|---|---|---|---|---|---|
| | | | | | | 3M | | 3L | | | |
| Size | W | H | A | A_{I} | H₁ min | B max | J₁ | B max | J₁ | J | G |
| 15 | 15 | 28 | 34 | 9.5 | 3 | 72 | 26 | 84 | 26 | 26 | M4 |
| 20 | 20 | 30 | 44 | 12 | 4 | 92 | 36 | 112 | 50 | 32 | M5 |
| 25 | 23 | 40 | 48 | 12.5 | 4.5 | 100 | 35 | 118 | 50 | 35 | M6 |
| 30 | 28 | 45 | 60 | 16 | 4.5 | 113 | 40 | 139 | 60 | 40 | M8 |
| 35 | 34 | 55 | 70 | 18 | 5.5 | 130 | 50 | 155 | 72 | 50 | M8 |
| 45 | 45 | 70 | 86 | 20.5 | 7 | 159 | 60 | 194 | 80 | 60 | M10 |
| 55 | 53 | 80 | 100 | 23.5 | 7.5 | 191 | 75 | 303 | 95 | 75 | M12 |
| 65 | 63 | 100 | 126 | 31.5 | 10 | 229 | 70 | 303 | 120 | 76 | M14 |

Therefore, the inventor has attempted to find an optimum diameter of each ball in order to achieve a linear motion guidance apparatus in which the rigidity can be increased while the movable block has a block length compliant with the relevant ISO standards described above and the load rating required in the linear motion guidance apparatus is maintained. A unique numerical analysis conducted by the inventor will be described in detail.

### [Verification of Idea (Numerical Analysis)]

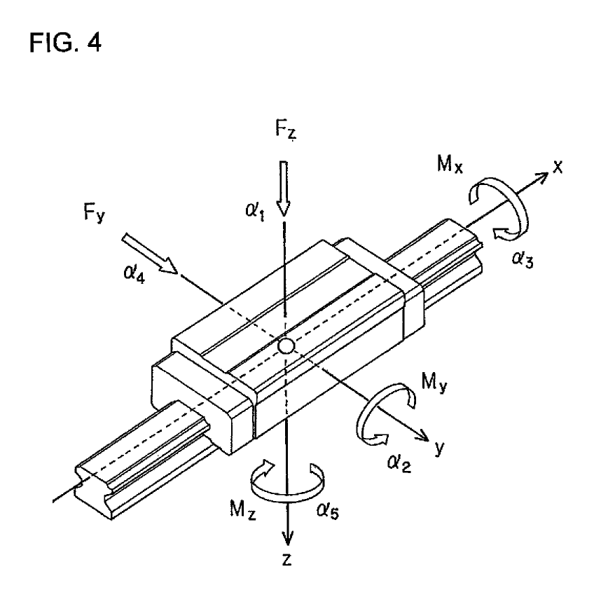

FIG. 4 shows the coordinate system of a linear motion guidance apparatus defined in a numerical analysis according to the present invention. It was assumed that external loads intended in the numerical analysis according to the present embodiment act on the origin of the coordinate system located at the center of the linear motion guidance apparatus, as shown in FIG. 4, and the waving amplitude at the origin of the coordinate system was calculated. Further, the analysis focused on the waving in the z-axis direction, that is, the vertical direction.

Further, in the numerical analysis according to the present embodiment, five model numbers (#15, #25, #45, #55, and #65: the figures stand for a dimension of a track rail in the width direction (unit: mm)) were in question, and the waving amplitude was calculated by changing the diameter of each ball and the length of a loaded rolling member rolling groove of the movable block and giving an optimum crowning shape for each of the ball diameters and each of the lengths of the loaded rolling member rolling groove of the movable block. The external load used in the numerical analysis was 0.1 C of pure radial load, and an optimum crowning depth was set at the amount of maximum elastic deformation of the ball produced when 0.1 C of pure radial load acts thereon with no crowing provided. The crowing used in the numerical analysis had a linear shape. Table 6 shows in detail the conditions of the numerical analysis according to the present embodiment.

TABLE 6
Analysis conditions

Unit: mm

| | Model number analyzed | | | | |
|---|---|---|---|---|---|
| | ^{#}15 | ^{#}25 | ^{#}45 | ^{#}55 | ^{#}65 |
| Reference length lₜ of | 50 | 100 | 150 | 200 | 250 |
| loaded rolling member | | | | | |
| rolling groove | | | | | |

| | |
|---|---|
| Diameter of ball | 0-0.1 lₜ (0.01 lₜ notch) |
| Length of loaded rolling | 0.8 lₜ, 1.0 lₜ, 1.2 lₜ, 1.4 lₜ |
| member rolling groove | |
| Basic dynamic load rating | Calculated by dedicated analysis software |

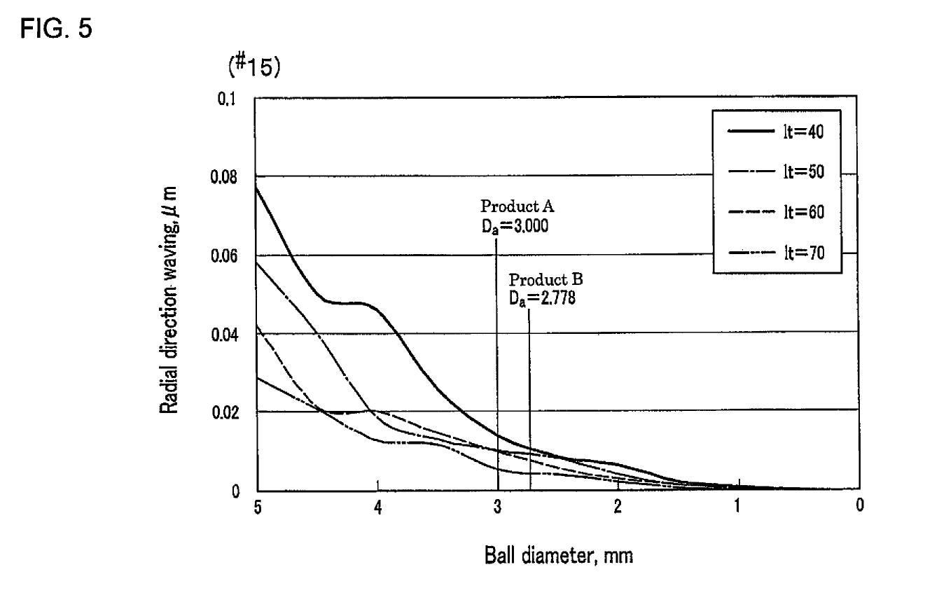

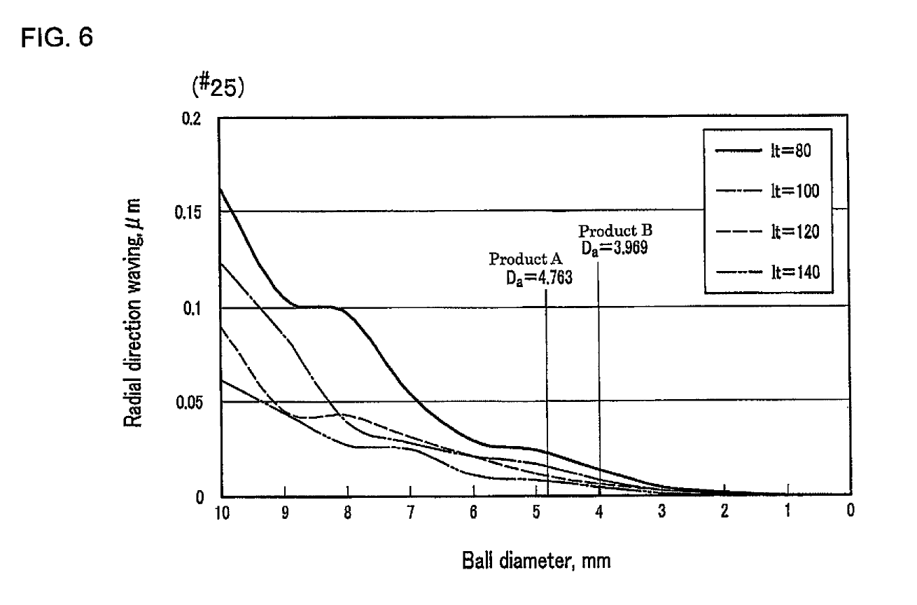

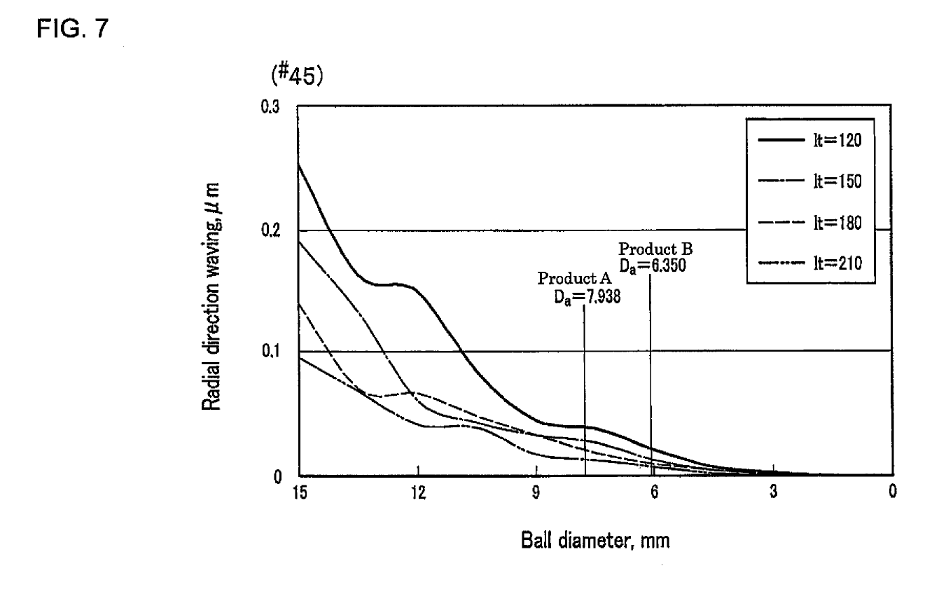

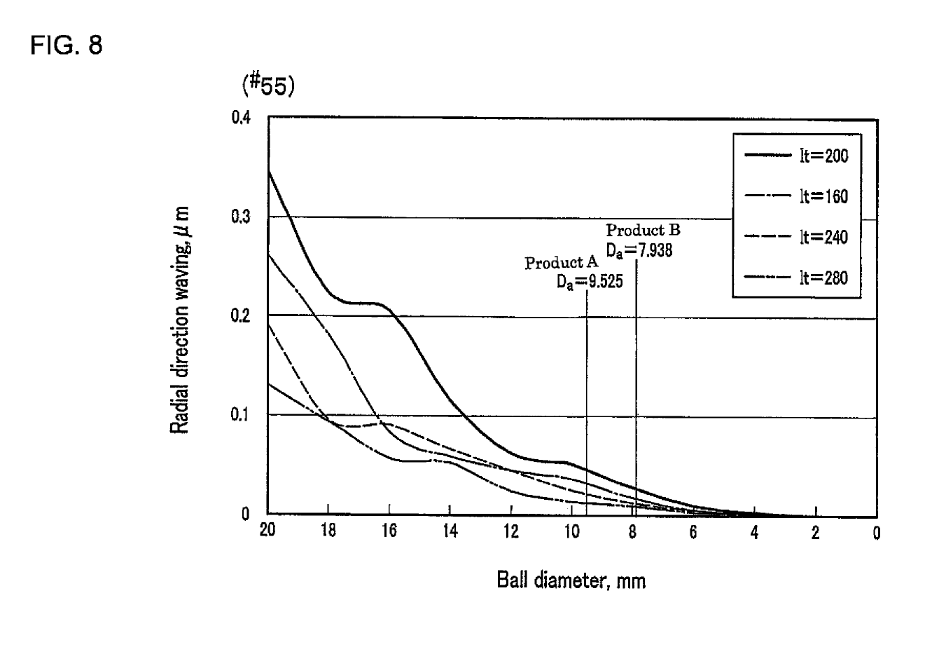

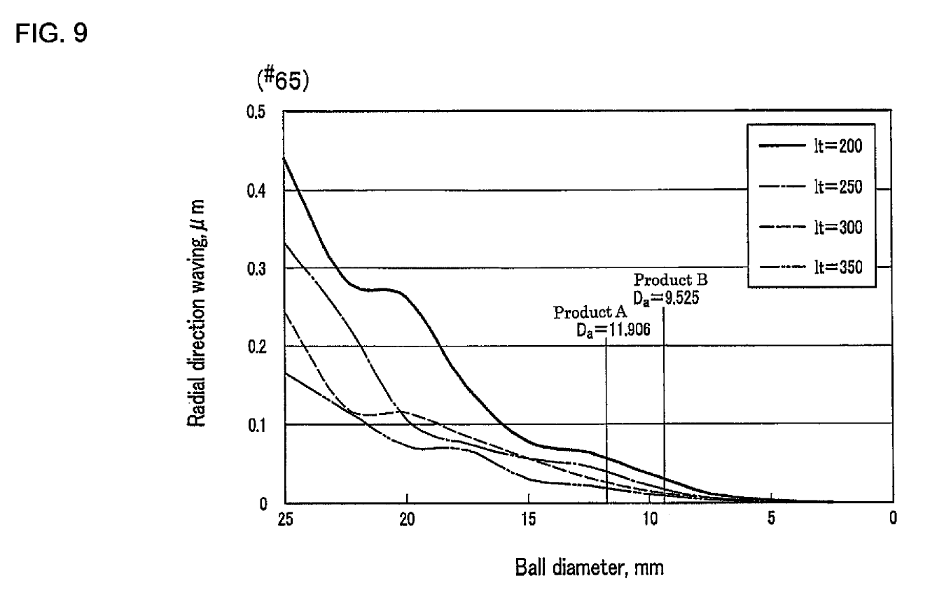

Carrying out the numerical analysis under the conditions described above provided the analysis results shown in FIGS. 5 to 9. FIGS. 5 to 9 show the relationship between the ball diameter and the waving amplitude obtained by changing the reference length lₜ of the loaded rolling member rolling groove for the model numbers (#15, #25, #45, #55, and #65). In FIGS. 5 to 9, those labeled with products A and B represent product series of conventional linear motion guidance apparatus that have been manufactured and marketed by the applicant, and the ball diameter (Dₐ) having been conventionally used in each of the product series is marked by a vertical line and shown as a reference value.

The results of the numerical analysis shown in FIGS. 5 to 9 show that the waving amplitude decreases as the ball diameter decreases for any of the reference lengths lₜ of the loaded rolling member rolling groove.

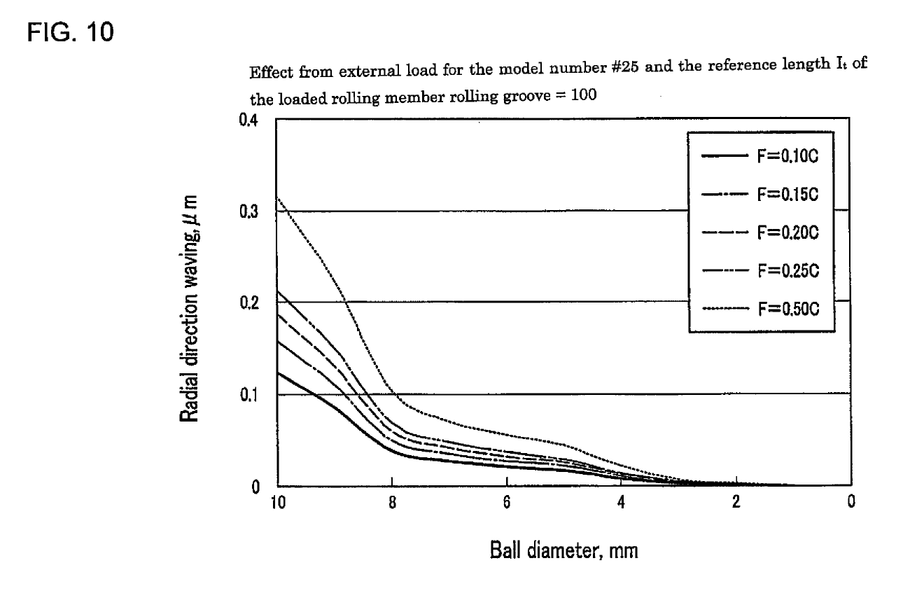

To further understand the influence of the external load of different amplitudes acting on the linear motion guidance apparatus, in addition to the findings described above, the relationship between the ball diameter and the waving amplitude was obtained by changing the external load from 0.10 to 0.50 C for the model number #25 and the reference length lₜ of the loaded rolling member rolling groove=100. FIG. 10 shows the results of the analysis. It is expected that the waving amplitude increases as the external load increases, as shown in FIG. 10, and FIG. 10 apparently shows that the waving amplitude still decreases as the ball diameter decreases for any amplitudes of the external load.

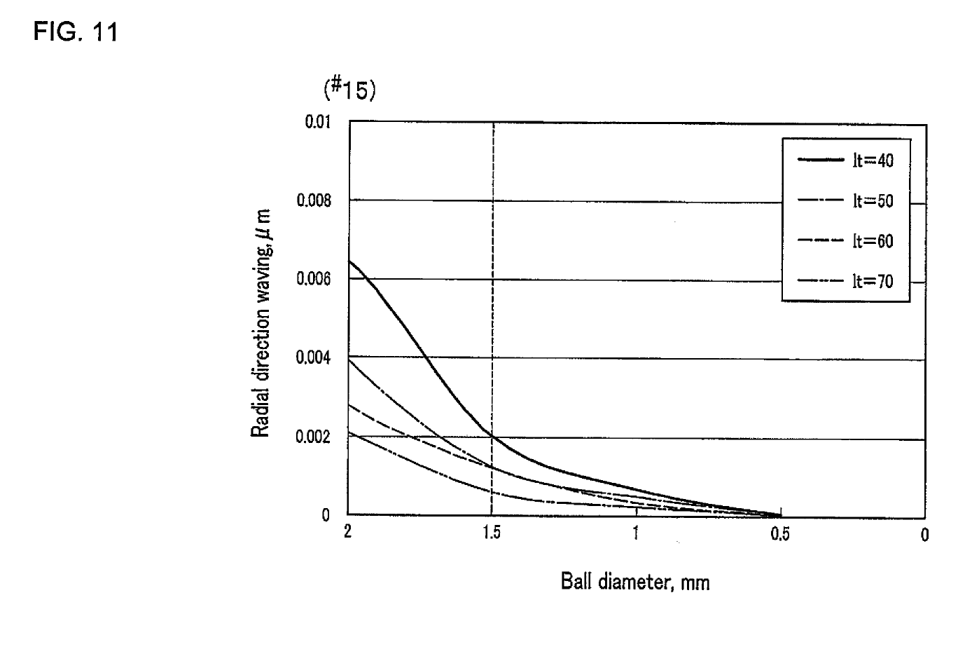

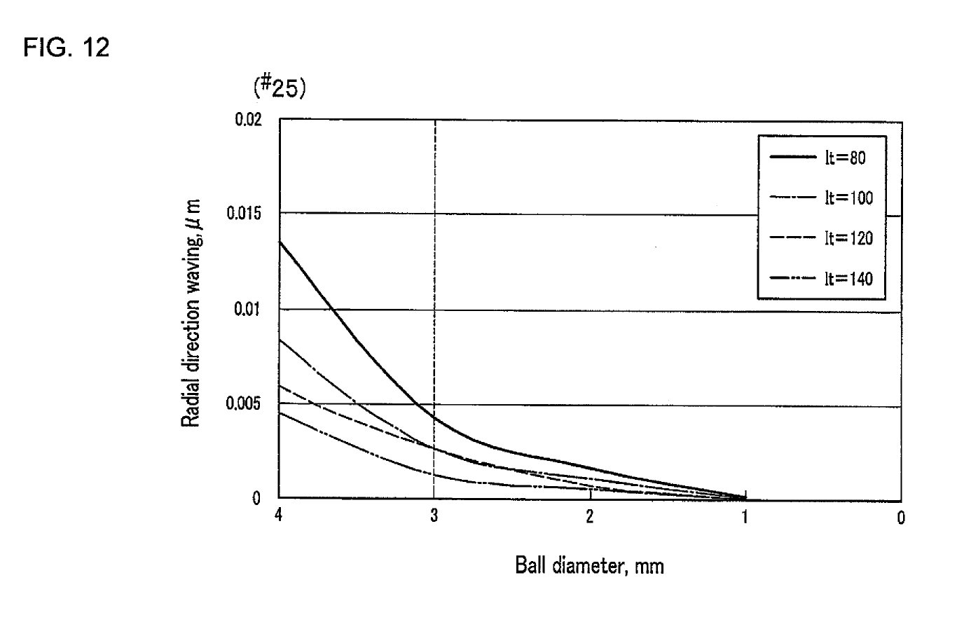

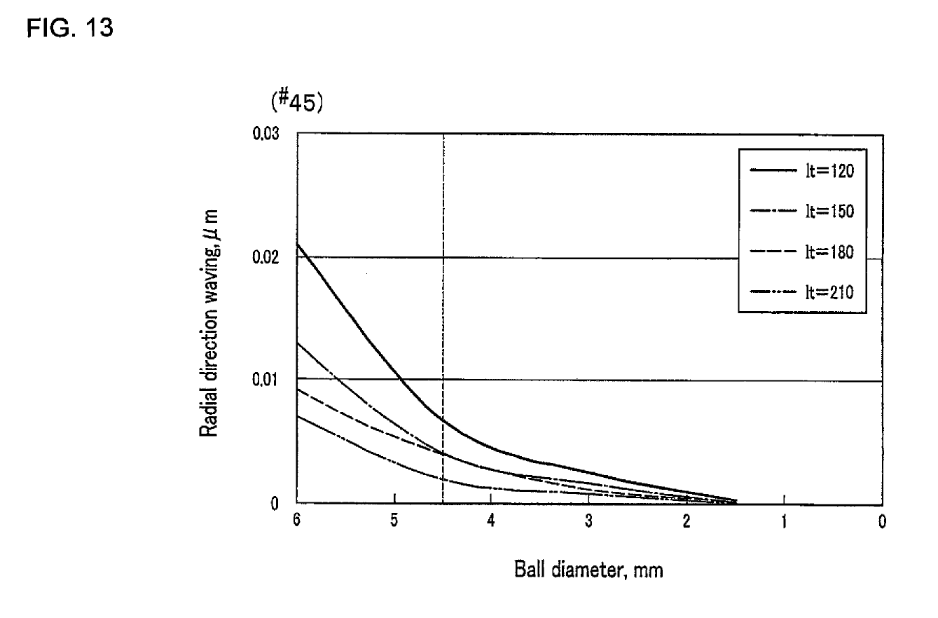

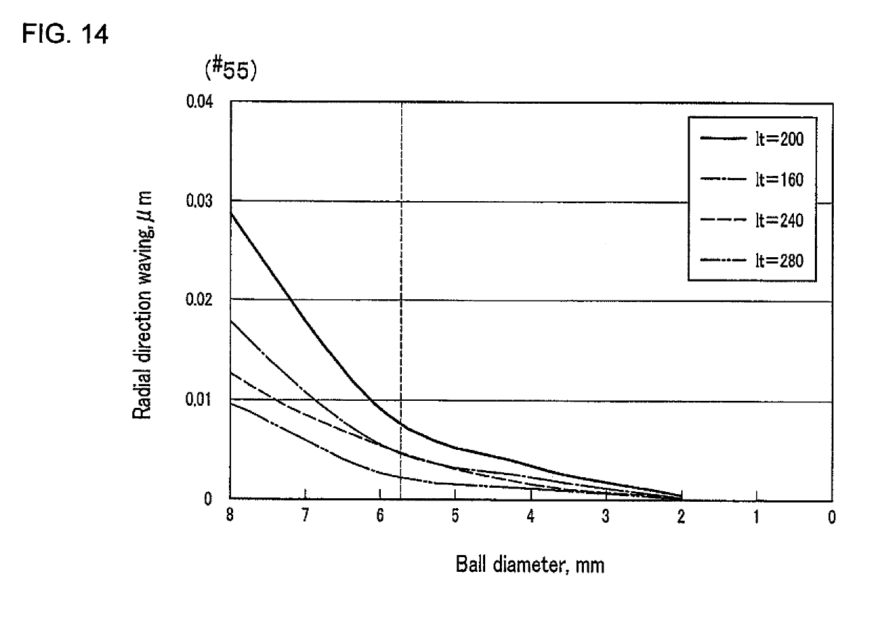

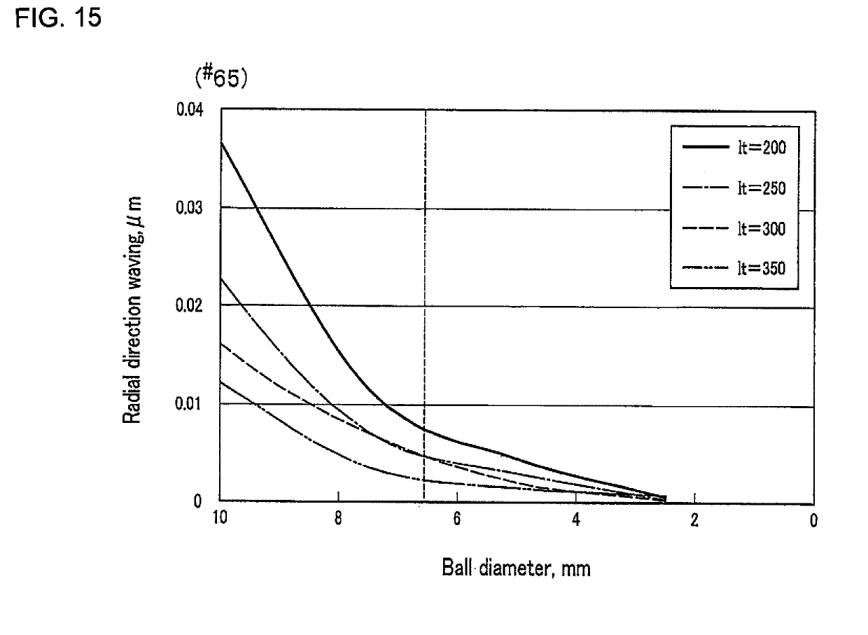

The inventor determined the relationship between the waving amplitude and the ball diameter for a waving amplitude of 0.05 μm or smaller by enlarging the waveforms obtained as the results of the numerical analysis shown in FIGS. 5 to 9 in order to determine an optimum ball diameter for a super-precision linear motion guidance apparatus having a waving precision ranging from 0.01 to 0.05 μm or an extra-super-precision linear motion guidance apparatus having a waving precision of 0.01 μm or smaller. FIGS. 11 to 15 show the results.

The results of the analysis shown in FIGS. 11 to 15 show that the waveforms shown in FIGS. 11 to 15 have inflection points indicated by the vertical broken lines in the figures; the waving amplitude varies greatly on the left side of the broken line where the ball diameter is large (that is, the influence of decrease in the ball diameter is large), whereas the waving amplitude does not vary greatly on the right side of the broken line (that is, reducing the ball diameter from the value on the broken line does not greatly reduce the waving amplitude).

The results of the analysis shown in FIGS. 11 to 15 further show the following points: For the model number #15, the waving amplitude gradually decreases as the ball diameter becomes smaller than 1.5 mm. For the model number #25, the waving amplitude gradually decreases as the ball diameter becomes smaller than from 3.0 mm. For the model number #45, the waving amplitude gradually decreases as the ball diameter becomes smaller than 4.5 mm. For the model number #55, the waving amplitude gradually decreases as the ball diameter becomes smaller than 5.7 mm. For the model number #65, the waving amplitude gradually decreases as the ball diameter becomes smaller than 6.5 mm.

The results described above are now reorganized as the relationship between the ball diameter and the width of the track rail. For the model number #15, the inflection point appears when the ball diameter is 1/10 of the width of the track rail. For the model number #25, the inflection point appears when the ball diameter is 1/8.33 of the width of the track rail. For the model number #45, the inflection point appears when the ball diameter is 1/10 of the width of the track rail. For the model number #55, the inflection point appears when the ball diameter is 1/9.65 of the width of the track rail. For the model number #65, the inflection point appears when the ball diameter is 1/10 of the width of the track rail. The results described above further indicate that the waving amplitudes at the inflection points range from 0.008 to 0.002 μm or smaller for all the model numbers and configuring a linear motion guidance apparatus in such a way that the ball diameter is 1/10 of the width of the track rail or smaller allows the linear motion guidance apparatus to be an extra-super-precision type in which the waving precision is 0.01 μm or smaller.

Further, it is apparent from the results of the analysis shown in FIGS. 11 to 15 that the waving amplitude tends to decrease as the lower limit of the ball diameter decreases, and it is expected that the ball diameter is preferably a smallest possible value close to 0 (zero) when there is no manufacturing technique limitation. In view of the current manufacturing techniques, however, a realistic lower limit of the ball diameter can be set at a value ranging from approximately 0.7 to 0.5 mm.

### [Further Improvement for Commercialization]

The inventor has further reached an idea that the number L of endless circulation paths is increased to prevent the load rating from decreasing due to decrease in the ball diameter, and has verified advantageous effects achieved by the idea.

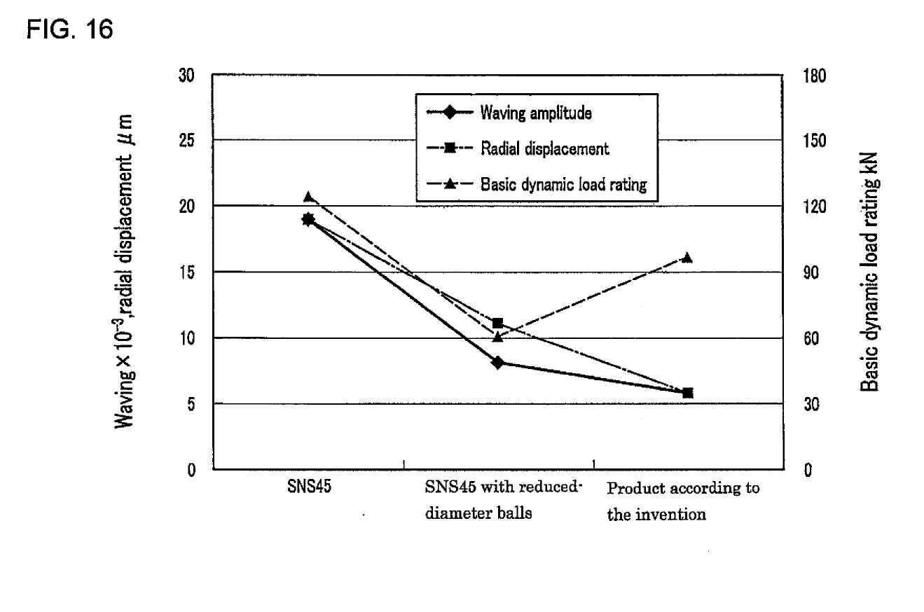

As a specific verification method, a linear motion guidance apparatus having been manufactured and marketed by the applicant, a product series SNS45, was used. In the method, three types of product were tested as shown in Table 7 below: SNS45 itself, which is a conventional product, a modified SNS45 in which the balls therein were reduced in size (that is, the ball diameter was 1/10 of the width of the track rail or smaller and the number of paths along which the balls endlessly circulate was 4), and another modified SNS45 in which the balls therein were reduced in size and the number of paths along which the balls endlessly circulate was 8. Analysis software was then used for each of the types of product to calculate the basic dynamic load rating, the waving amplitude, and the radial displacement. Table 7 and FIG. 16 show the results of the analysis. The line graphs shown in FIG. 16 are drawn to compare the results of the analysis shown in Table 7 for the types described above.

TABLE 7
Products to be analyzed and results of analysis

| | Basic | Waving | Radial |
|---|---|---|---|
| | dynamic load | amplitude | displacement |
| Type | rating kN | nm | μm |
| SNS45 | 125.4 | 19.2 | 19.1 |
| SNS45 with reduced- | 61.3 | 8.2 | 11.1 |
| diameter balls | | | |
| Product according to | 97.1 | 6.0 | 5.8 |
| the invention | | | |
| (reduced-diameter | | | |
| balls and eight paths) | | | |

Comparing SNS45, which is a conventional product, with the modified SNS45 in which the ball diameter is reduced, one can see that the waving amplitude and the radial displacement decrease (are improved), but the basic dynamic load rating decreases (is degraded), resulting in a concern about decrease in guidance performance as a linear motion guidance apparatus.

For the modified SNS45 in which the ball diameter was reduced and the number of paths along which the balls endlessly circulate was 8, however, the waving amplitude and the radial displacement further decrease (are improved), and the basic dynamic load rating is greatly improved (become better), as compared with those of the modified SNS45 in which only the ball diameter was reduced. This result of the analysis apparently shows that the linear motion guidance apparatus according to the present invention characterized by the combination of “reduced-diameter balls” and “eight paths” can maintain the motion guidance capability (basic dynamic load rating) at approximately the same level as a conventional level and drastically improve the precision in motion, which are very significant advantageous effects.

It is considered preferable that the number of paths L along which the balls endlessly circulate is 4×N (N is a natural number greater than or equal to two) in consideration of achieving a linear motion guidance apparatus capable of traveling in a balanced, stable manner. A realistic number of paths L may be set at a value that satisfies the equation described above and is preferably set at 8 to provide a linear motion guidance apparatus compliant with ISO.

As a summary, reducing the diameter of the balls used in a linear motion guidance apparatus, specifically, setting the ball diameter to be 1/10 of the width of the track rail or smaller, has been proved to minimize the possibility of the waving occurring.

Further, increasing the number of paths along which the balls endlessly circulate, specifically, setting the number of ball paths L at 4×N (N is a natural number greater than or equal to two), allows the number of balls used in a linear motion guidance apparatus to be increased and prevents decrease in load rating, which is a concern when the ball diameter decreases. It has been further shown that increasing the number of ball paths advantageously suppresses the possibility of the waving occurring (see FIG. 16).

Both the measures of “reducing the ball diameter” and “increasing the number of paths” lead to increase in the number of balls incorporated in a linear motion guidance apparatus, which is significant in terms of reducing the load or contact pressure acting on a single ball, and this advantageous effect improves the precision in motion of the linear motion guidance apparatus (for example, attitude change and vibration (pulsing motion) of the movable block are minimized). Further, since the measures of “reducing the ball diameter” and “increasing the number of paths” lead to not only maintaining the movable block length compliant with ISO but also increasing the number of incorporated balls as described above, synergy between the “reducing the ball diameter” and “increasing the number of paths” achieves improvement in the precision in motion of the linear motion guidance apparatus. It is noted that since “reducing the ball diameter” also contributes to increase in volume of the movable block, the rigidity of the movable block is improved and the precision in motion of the linear motion guidance apparatus is improved accordingly.

### [Specific Example of Linear Motion Guidance Apparatus]

An example of the linear motion guidance apparatus that satisfies the above preferred conditions found by the inventor will be described with reference to the corresponding drawings. The following example does not limit the invention set forth in the claims, and all combinations of the features described in the example are not necessarily essential for “Means for Solving the Problems.”

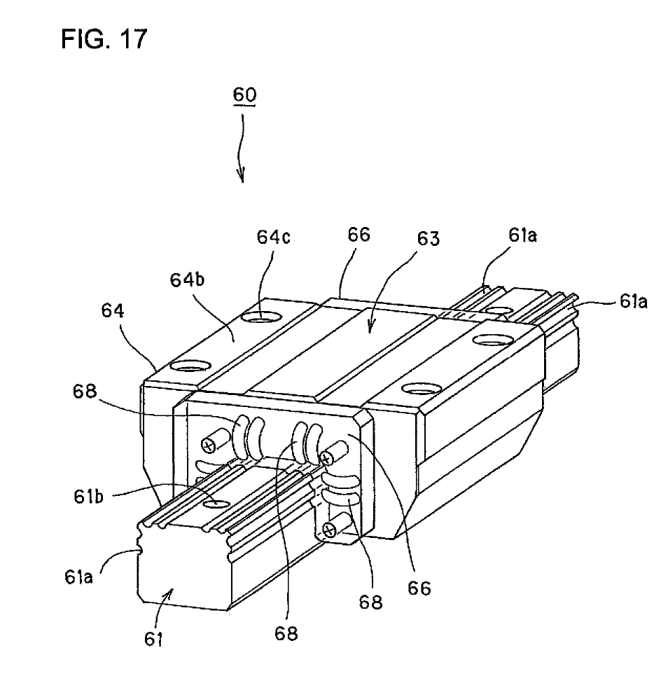

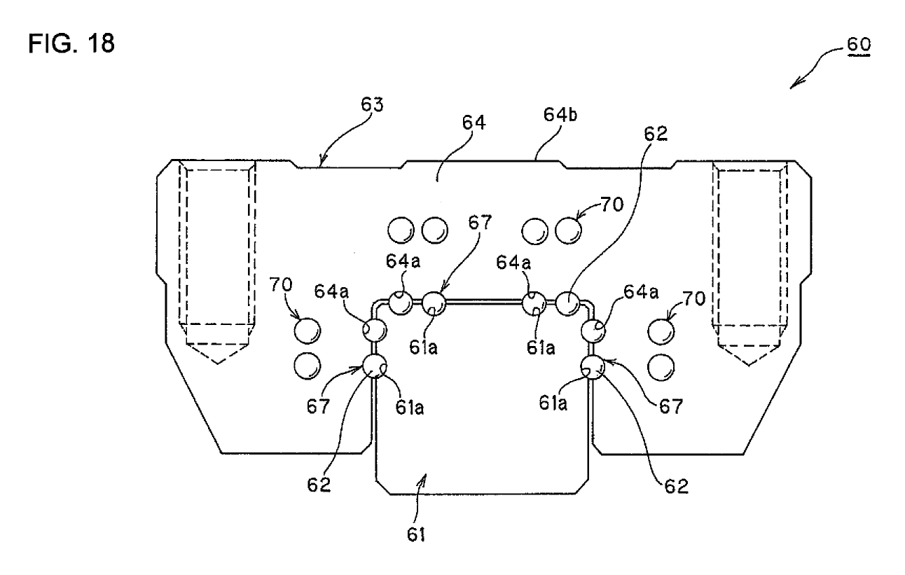

FIGS. 17 and 18 show one form of the linear motion guidance apparatus according to the present example. Specifically, FIG. 17 is an exterior perspective view of the linear motion guidance apparatus according to the present example, and FIG. 18 is a longitudinal cross-sectional view of the linear motion guidance apparatus according to the present example. The linear motion guidance apparatus 60 according to the present example includes a track rail 61, a plurality of balls 62 . . . , and a movable block 63 attached to the track rail 61 via the plurality of balls 62.

The track rail 61 is an elongated member having a substantially rectangular cross-sectional shape, and rolling member rolling grooves 61a capable of receiving the balls 62 are formed along the longitudinal direction on the upper surface and both side surfaces of the track rail 61. In the linear motion guidance apparatus according to the present example, four rolling member rolling grooves 61a are formed on the upper surface of the track rail 61, and two rolling member rolling grooves 61a are formed on each of the side surfaces of the track rail 61. As a result, eight rolling member rolling grooves 61a in total are formed across the track rail 61. A plurality of bolt attachment holes 61b are formed through the track rail 61 at appropriate spacings in the longitudinal direction. The track rail 61 is fixed to a predetermined attachment surface, for example, the upper surface of a bed of a machine tool, with bolts (not shown) screwed through the bolt attachment holes 61b. While the track rail 61 shown in FIGS. 17 and 18 has a linear shape, a curved rail having a fixed curvature may alternatively be used in some cases.

The movable block 63 includes a movable block body 64 made of a material having high strength, such as steel, and a pair of side lids 66, 66 fixed to both ends of the movable block body 64 with bolts (not shown).

Eight loaded rolling member rolling grooves 64a that face the respective rolling member rolling grooves 61a on the track rail 61 are provided on the movable block body 64. The rolling member rolling grooves 61a are combined with the loaded rolling member rolling grooves 64a to form eight loaded rolling paths 67 between the track rail 61 and the movable block 63. A plurality of (four in FIG. 17) female screws 64c are formed in the upper surface 64b of the movable block body 64, and the female screws 64c are used to fix the movable block 63 to a predetermined attachment surface, for example, the lower surface of a saddle or a table of a machine tool.

Unloaded rolling paths 70 substantially parallel to the eight loaded rolling member rolling grooves 64a are formed in the movable block body 64. Eight direction reversing paths 68 through which the ends of the loaded rolling paths 67 communicate with the corresponding ends of the unloaded rolling paths 70 are formed in the pair of side lids 66, 66, which are fixed to both ends of the movable block body 64, and attaching the eight direction reversing paths 68 to the movable block body 64 allows the loaded rolling paths 67 to communicate with the unloaded rolling paths 70 and forms eight endless circulation paths. Since the linear motion guidance apparatus 60 according to the present example is thus configured, the movable block 63 can make reciprocating motion in the longitudinal direction of the track rail 61.

In the linear motion guidance apparatus 60 according to the present example described above, the diameter of each of the balls 62 is 1/10 of the width of the track rail 61 or smaller, and the movable block 63 has a block length B_{MAX} compliant with ISO. Since the linear motion guidance apparatus 60 according to the present example employs the configuration described above in which the diameter of the each of the balls 62 is reduced, the waving phenomenon can be minimized and the precision in motion is improved.

Further, the linear motion guidance apparatus 60 according to the present example has eight endless circulation paths L formed of the loaded rolling paths 67, the unloaded rolling paths 70, and the pair of direction reversing paths 68, 68. The configuration of the linear motion guidance apparatus 60 according to the present example, in which the diameter of each of the balls 62 is 1/10 of the width of the track rail 61 or smaller in order to minimize the waving phenomenon, could disadvantageously reduce the load rating of the linear motion guidance apparatus 60. The load rating is improved by increasing the number of endless circulation paths, that is, the number of paths along which the balls 62 endlessly circulate, whereby the influence of the decrease in the diameter of each of the balls 62 is eliminated. Employing the configuration described above achieves the precision in motion provided in the class called extra-super-precision and allows the linear motion guidance apparatus 60 to maintain a load rating equivalent to that of a conventional linear motion guidance apparatus.

Further, in the linear motion guidance apparatus 60 according to the present example, since the diameter of each of the balls 62 is reduced and the external dimension of the movable block 63 still complies with the relevant ISO standards, the proportion of the loaded rolling paths 67 and the unloaded rolling paths 70 to the movable block body 64 and other components is small, whereby the rigidity of the movable block body 64 can be advantageously improved.

Moreover, according to the linear motion guidance apparatus 60 of the present example, since the length of the movable block 63 complies with the relevant ISO standards, the linear motion guidance apparatus 60 has a high degree of flexibility.

The preferred example of the present invention has been described above, but the technical scope of the present invention is not limited to that set forth in the example described above. A variety of changes or improvements can be made to the example described above.

For example, while the linear motion guidance apparatus 60 according to the present example shown in FIGS. 17 and 18 is configured in such a way that the number L of endless circulation paths is eight, the number L of endless circulation paths formed of the loaded rolling paths 67, the unloaded rolling paths 70, and the pair of direction reversing paths 68, 68 may be any value that satisfies the equation 4×N (N is a natural number greater than or equal to two). Specifically, the number of paths L may be 12 or 16.

It is apparent from the description of the claims that the technical scope of the present invention encompasses a variety of forms to which such changes or improvements are made.

1-4. (canceled)

5. A linear motion guidance apparatus comprising:
a track rail on which rolling member rolling grooves are formed along the longitudinal direction;
a movable block on which loaded rolling member rolling grooves that face the rolling member rolling grooves are formed; and
a plurality of balls rollably provided in loaded rolling paths formed of the rolling member rolling grooves and the loaded rolling member rolling grooves,
the movable block being thereby capable of making reciprocating motion in the longitudinal direction of the track rail,
characterized in that the diameter of each of the balls is 1/10 of the width of the track rail or smaller.

6. A linear motion guidance apparatus comprising:
a track rail on which rolling member rolling grooves are formed along the longitudinal direction;
a movable block on which loaded rolling member rolling grooves that face the rolling member rolling grooves are formed; and
a plurality of balls rollably provided in loaded rolling paths formed of the rolling member rolling grooves and the loaded rolling member rolling grooves,
the movable block being thereby capable of making reciprocating motion in the longitudinal direction of the track rail,
characterized in that the diameter of each of the balls is 1/10 of the width of the track rail or smaller and the movable block has a block length compliant with ISO.

7. The linear motion guidance apparatus according to claim 5,
characterized in that the movable block includes
a movable block body on which the loaded rolling member rolling grooves are formed and in which unloaded rolling paths substantially parallel to the loaded rolling member rolling grooves are formed, and
a pair of side lids in which direction reversing paths that allow the ends of the loaded rolling paths to communicate with the corresponding ends of the unloaded rolling paths are formed, the pair of side lids attached to both ends of the movable block body, and
the number L of endless circulation paths formed of the loaded rolling paths, the unloaded rolling paths, and the pair of direction reversing paths is 4×N (N is a natural number greater than or equal to two).

8. The linear motion guidance apparatus according to claim 7,
characterized in that the number L of endless circulation paths is eight.

9. A linear motion guidance apparatus comprising:
a track rail on which rolling member rolling grooves are formed along the longitudinal direction;
a movable block on which loaded rolling member rolling grooves that face the rolling member rolling grooves are formed; and
a plurality of balls rollably provided in loaded rolling paths formed of the rolling member rolling grooves and the loaded rolling member rolling grooves,
the movable block being thereby capable of making reciprocating motion in the longitudinal direction of the track rail,
characterized in that the diameter of each of the balls is 1/10 of the width of the track rail or smaller and the movable block has a block length compliant with ISO.

10. The linear motion guidance apparatus according to claim 6,
characterized in that the movable block includes
a movable block body on which the loaded rolling member rolling grooves are formed and in which unloaded rolling paths substantially parallel to the loaded rolling member rolling grooves are formed, and
a pair of side lids in which direction reversing paths that allow the ends of the loaded rolling paths to communicate with the corresponding ends of the unloaded rolling paths are formed, the pair of side lids attached to both ends of the movable block body, and
the number L of endless circulation paths formed of the loaded rolling paths, the unloaded rolling paths, and the pair of direction reversing paths is 4×N (N is a natural number greater than or equal to two).
